(19) United States
(12) Patent Application Publication
(10) Pub. No.: US 2022/0004623 A1
(43) Pub. Date: Jan. 6, 2022

(54) MANAGED ISOLATED WORKSPACE ON A USER DEVICE

(71) Applicant: Hysolate LTD., Tel Aviv-Yafo (IL)

(72) Inventors: Tomer TRABELSI, Tel Aviv (IL); Nir ADLER, Netanya (IL); Boris FIGOVSKY, Hadera (IL); Oleg ZLOTNIK, Nesher (IL); Tal ZAMIR, Tel Aviv (IL)

(73) Assignee: Hysolate Ltd., Tel Aviv-Yafo (IL)

(21) Appl. No.: 17/368,355

(22) Filed: Jul. 6, 2021

Related U.S. Application Data
(60) Provisional application No. 63/048,447, filed on Jul. 6, 2020.

(51) Int. Cl. G06F 21/53; H04L 29/06; G06F 9/451; G06F 9/455

(52) U.S. Cl. CPC G06F 21/53; H04L 63/0272; H04L 63/029; G06F 2221/033; G06F 9/45545; G06F 9/45558; G06F 2009/45587; G06F 9/452

(57) ABSTRACT

A method and system for method for providing a managed and isolated workspace on a user device are provided. The method creating a secured workspace in the user device, wherein the secured workspace is separated from a host operating system and includes a guest operating system; monitoring activity performed in the secured workspace and host operating system; determining, based on a security policy, if the monitored activity is risky; and causing execution of any determined risky activity in the secured workspace, thereby defending the host operating system from the determined risky activity, wherein the host operating system executes sensitive applications to an organization.

### CROSS-REFERENCE TO RELATED APPLICATIONS

This application claims the benefit of U.S. Provisional Application No. 63/048,447 filed on Jul. 6, 2020, the contents of which are hereby incorporated by reference.

### TECHNICAL FIELD

The present disclosure relates generally to security systems, and more specifically to allowing virtualization-based security using virtual computing.

### BACKGROUND

Securing user devices is a real challenge when users of an organization use their own devices, or managed devices accessing external risky content. In the related art, there are a number of solutions attempting to isolate different computing environments on a single computer. However, such solutions do not provide a solution that can fully isolate risky content—including files, networks, applications, and external devices. Furthermore, such solutions often suffer from user experience limitations.

For example, an isolation solution can be based on virtual machine (VM) technologies. That is, VMs are containers in which applications and guest operating systems can be executed. By design, all VMs are isolated from one another. This isolation enables multiple virtual machines to run securely while sharing hardware.

Another solution is based on a remote desktop or a remote browser that isolates sensitive/risky resources from the user's device. Each of the existing isolation solutions suffer from limitations of insufficient security controls, insufficient enterprise manageability, insufficient application/website compatibility, and/or lacking user experience affected by network connectivity.

Other security risks are introduced with remote working, where an employee of an organization works outside of the organization. Organizations typically secure any access to their networks using firewalls and other cyber security means (e.g., anti-virus software, anti-malware software, and the like). Employees working outside of the organization (e.g., from home), and typically with their own device, do not have such means installed. This imposes a significant security risk for the organization.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for providing a managed and isolated workspace on a user device. The method comprises creating a secured workspace in the user device, wherein the secured workspace is separated from a host operating system and includes a guest operating system; monitoring activity performed in the secured workspace and host operating system; determining, based on a security policy, if the monitored activity is risky; and causing execution of any determined risky activity in the secured workspace, thereby defending the host operating system from the determined risky activity, wherein the host operating system executes sensitive applications to an organization.

Certain embodiments disclosed herein include a system for providing a managed and isolated workspace on a user device. The system comprises a processing circuitry; and a memory, the memory containing instructions that, when executed by the processing circuitry, configure the system to: create a secured workspace in the user device, wherein the secured workspace is separated from a host operating system and includes a guest operating system; monitor activity performed in the secured workspace and host operating system; determine, based on a security policy, if the monitored activity is risky; and cause execution of any determined risky activity in the secured workspace, thereby defending the host operating system from the determined risky activity, wherein the host operating system executes sensitive applications to an organization.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the disclosed embodiments.

FIG. 2 is a block diagram illustrating the arrangement of a secured workspace in a user device according to an embodiment.

FIG. 3 is a diagram illustrating the operation of the virtual network interface to provide network communication protection according to an embodiment.

FIG. 4 is a flowchart illustrating the operation of the secured workspace in a user device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

By way of example to the disclosed embodiments, a secured workplace configured to secure organization resources or assets when executed or accessed from a user device is provided. The user device may be a device of the user, or a device provided by the organization. The latter is typically installed with some cyber-security defense applications and configured with some restrictions. The secure workplace is a managed and isolated virtual environment that can be instantly created on user devices. The creation of a secured workplace is performed without managing or reinstalling an operating system image. The control of the secured workplace is managed and governed by the organization from a remote system, where such a system is typically installed in the cloud computing environment.

The disclosed embodiments provide an improved security for organizations where users (employees) of the organization execute critical applications from devices that may be managed or unmanaged by the organization. Managed devices may be compromised after accessing external/risky content, while unmanaged devices are completely exposed to both external and insider threats. The disclosed embodiments further provide improvement over remote connection solutions, as in the proposed secured workspace, applications are executed locally where only the security features of the workspace are configured remotely.

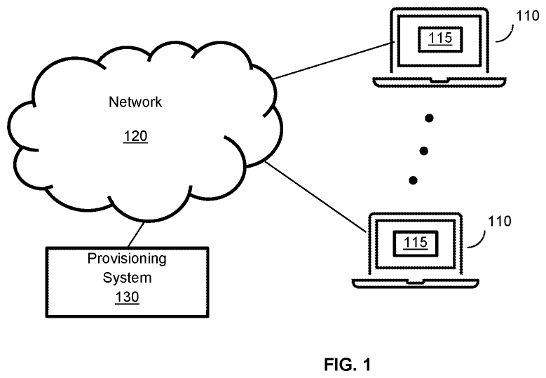

FIG. 1 is an example network diagram 100 utilized to describe the disclosed embodiments. As illustrated in FIG. 1, a plurality of user devices 110-1 through 110-N are connected to a network 120. Also connected to the network 120 is a provisioning system 130. A user device 110 may be provided, configured, and managed by the organization (corporate). A user device 110 may be a personal device of the user and not belong to the organization. A user device 110 may include a laptop computer, a tablet computer, a desktop computer, a smart phone, a wearable device, and the like. The network 120 is typically the Internet but may also include a local area network (LAN).

In the example shown in FIG. 1, the user devices 110 are of users (e.g., employees) of the organization that may access computing resources 140 of the organization over the network 120. The computing resources 140 may be deployed in a cloud computing environment, on-premises, a datacenter, and the likes, or combination thereof. The computing resources 140 may include servers, databases, or any compute that can execute applications of the organization, and/or storage that stores information that may include sensitive information of the organization.

According with the disclosed embodiments, each user device 110 includes one secured workspace 115 created on-demand. The creation and provisioning of the secured workspaces 115 is controlled and managed by the provisioning system 130. The provisioning system 130 is installed in the organization environment which may be a cloud computing environment, on-premises, a datacenter, and the likes, or combination thereof.

In an embodiment, the provisioning system 130 together with secured workspace 115 provides a strong virtual-based isolation of organization computing resources 140. The provisioning system 130 can configure for each secured workspace 115 with a security policy which may be different or the same for all user devices of the organization. The security policy includes at least a catalog of trusted applications and services, a network policy, a user interface (UX) policy, a connectivity policy, a browsing policy, and other like.

The network policy defines a set of permissions for applications executed in the secured workspace 115. Examples for such permissions include a full access to a network resource, a limited access to a network resource, access is permitted after authentication, and so on.

The UX policy defines which user interface actions are allowed to be performed by the user in the workspace. Examples for such actions include, but are not limited to, clipboard, printing, screenshotting, and the like. As an example, the UX policy can define if the user can copy content and paste such content in a different workspace, or if the content from a different workspace can be pasted in the current workspace. Content may include, for example, text, an image, a file, and the like. The UX policy may also designate what type of content can be copied, pasted, or both.

The browsing policy defines a whitelist of URLs or domain names that can be accessed from a browser. This allows, for example, blocking browsers from accessing malicious URLs when the user mistakenly browses to such URLs in the wrong security workspace. In an optional embodiment, the blocked URL can be accessed and launched only in the secured workspace 115 which is allowed to access that URL.

The connectivity policy defines a set of allowed peripheral devices through wired or wireless connections. As an example, the connectivity policy may define if connections through a USB plug are allowed or restricted. Restricted connectivity may limit all connections or connections to designated USB devices (e.g., printer but not Flash Drive). Examples for other wired connections may include, for example, DisplayPort®, Thunderbolt™, HDMI®, PS/2, and the like. Wireless connections may include short range connections that allow wireless docking of peripheral devices (e.g., WiGig™), and the like. In an embodiment, connection to a peripheral device may be allowed only from the secured workspace 115.

In an embodiment, the system 130 is configured to create the secured workspace 115 by first preparing a virtual machine (VM) in advance. Such VM can be created either from existing OS file binaries, a clean OS version, or a pre-defined custom OS version with pre-installed applications. A secured workspace 115 can be pre-installed with one or more applications of the organization (corporate) and run locally on a user device 110. The applications are executed in a guest OS, which is part of the secured workspace 115.

Therefore, execution of such applications does not require complex or expensive backend infrastructure. Further, the secured workspace 115 enables secure access on devices owned by employees and secure privileged access to computing resources 140 from a separate and isolated operating system. This is performed by directing any execution of “risky” operations to the secured workspace 115 and not on the host operating system. Examples for such operations include, but are not limited to, running applications, web browsing, opening attachments and installing applications in a contained and off-network environment, and provide access to the organization environment from their devices without cross contaminating your environment and theirs.

In an embodiment, a secured workspace 115 appears to the user as a native additional desktop on a respective user device 110. For example, the secured workspace 115 may include a unique wallpaper and/or color scheme indicating that it is a separate desktop. Further, the workspace 115 can be displayed on part of the screen or the entire screen. It can also be displayed on a designated monitor in a multi-monitor environment. In some embodiments, the workspace 115 may correspond to a different identity of the user. In yet another embodiment, a user interface (UI) appearance may be changed when launching the workspace. For example, the different appearance may be realized using coloring, avatar, animation, and visual cues to differentiate the workspace 115.

Modern operating systems have a concept of multiple “desktops”. The separate sets of windows that can be used for different purposes. For better usability, the secured workspace 115 can be shown as occupying the entire screen of one of these operating system desktops. The user can then flip between the corporate environment (host OS) and the secured workspace 115 in a similar way when flipping between desktops in an operating system.

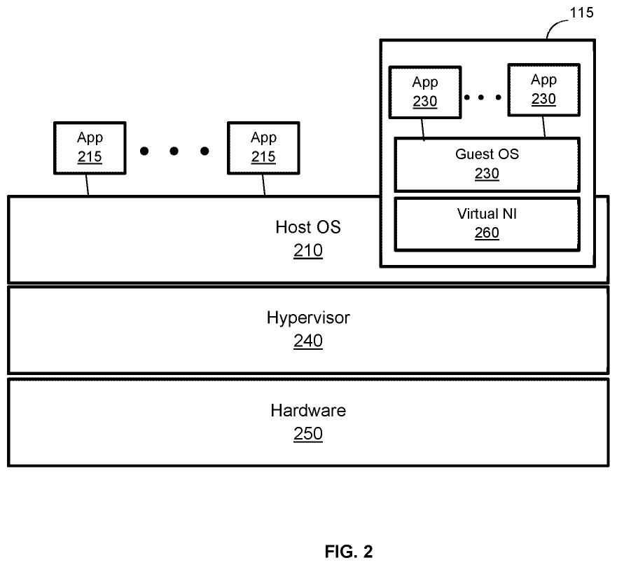

FIG. 2 is an example block diagram 200 illustrating the arrangement of a secured workspace 115 in a user device according to an embodiment. The secured workspace 115 is executed over a host operating system (OS) 210. The host OS 210 may include, for example, Windows®, iOS®, Linux®, Android, and the like. The workspace 115 includes the controls, such as network, external device, UI operations, re-direction of web traffic, and so on. Such controls are governed by a set of policies, example of which are provided above.

In an embodiment, the secured workspace 115 is realized as a virtual machine executing a plurality of applications 220 over a guest OS 230. Here, the secured workspace 115 is configured to host and execute applications (230) considered to be risky for execution by the host OS 210. For example, the host OS 210 may execute corporate applications (215) and the secured workspace 115 would run untrusted content and applications 220. The secured workspace 115 is completely isolated from the host OS 210. That is, an application 220 executed in workspace 115 cannot access any content or applications (215) executed in or accessed by the host OS 210.

Furthermore, the secured workspace 115 can protect corporate applications, content, and assets, even if such are executed over or accessed by a user device not controlled by the organization. The guest OS 220 and any applications 225 are executed over the workspace 115. The guest OS 220 may be an operating system, such as Windows®, iOS®, Linux®, Android, and the like.

The host OS 210 is executed over a hypervisor 240 being configured to instantiate and control the secured workspace 115. The hypervisor 240 is also configured to virtualize hardware services, of hardware 250, to applications 220 in the workspace 115. This allows for programming the hypervisor 240 with a significantly lower number of code lines, thereby reducing the risks of vulnerabilities that can be exploited by, for example, the guest OS 230.

The hardware 250 may include components such as of those that can be found in a standard desktop or laptop computer. The hardware 250 may include, for example, a processing circuitry, a memory, a storage, a network interface card (NIC), input/output (I/O) peripherals, a graphics processing unit (GPU), and a sound card. Such components are not shown in FIG. 2.

The processing circuitry may be realized by one or more hardware logic components and circuits. For example, and without limitation, a general-purpose microprocessor, a central processing unit (CPU), a multi-core CPU, a digital signal processor (DSP), and the like, or any other hardware logic components that can perform calculations or other manipulations of information. The memory may be volatile (e.g., RAM, etc.), non-volatile (e.g., ROM, flash memory, etc.), or a combination thereof. The storage may be magnetic storage, optical storage, and the like and may be realized, for example, as flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information.

The NIC allows the endpoint to communicate with external networks over a wired connection, a wireless connection, or both. The NIC may transmit communication media, receive communication media, or both. For example, the NIC may in a form of a modem, an integrated network interface, a radio frequency transmitter/receiver, an infrared port, a USB connection, and the like. The I/O peripheral allows connectivity to external peripherals, such as a disk drive, printers, wireless keyboard, pointing device, a microphone, a speaker, a docking station, and the like. The I/O peripherals may allow connectivity through USB ports, PS/2 ports, Infrared ports, and the like. The GPU provides connectivity to a monitor display.

The sound card (or audio card) provides input and output of audio signals to and from an endpoint under control of guest OS. It should be noted that other hardware components are included in a typical hardware of an endpoint which are not illustrated herein. Such components may include, but are not limited to, a motherboard, a power source, and the like.

The secured workspace 115 is configured to implement several security controls designed to secure the organization's resources while providing seamless user experience. In an embodiment, any traffic generated by applications 220 controlled by the workspace 115 is tunneled outside of the organization network. Such tunneling may be required when the host OS is 210 running corporate applications and is connected to the corporate network, while the guest OS 230 executes risky applications 220 and must not be able to communicate with targets in the corporate network. Therefore, it is desired to force-tunnel the guest OS traffic outside of the corporate network, so that the guest OS only sees the external network/internet, and will not have access to any internal corporate network resources.

In yet another embodiment, when an application is launched or a file is opened, the workspace 115 is configured to enforce restrictions on such objects. This may include launching the application in the secured workspace 115.

In another embodiment, when the application is launched or executed in the workspace, the application's traffic is tunneled to an unsecure network (e.g., the Internet). This may be performed in response to detecting that the user device is currently connected to the organization network.

In yet another embodiment, resources accessed by applications 230 (in the workspace 230) are filtered based on usage of resources in another locked environment. A list of resources that are inaccessible (e.g., filtered) to an unsecured environment is the same as a list of resources accessible by the secured workspace 115.

In yet another embodiment, a user identity, a persona, or profile of a user of the user device is bound to a specific environment. The secure workspace 115 is configured to force a user login to the secure workspace 115 using a specific identity/persona/domain and no other.

In yet another embodiment, keystroke injection protection is provided by secure workspace 115. Here, the secure workspace 115 limits the rate of keystroke injection to keystroke pace of a typical human operator or prevents the injection of keys into the window representing the virtual machine.

In yet another embodiment, the secure workspace 115 is non-persistent, i.e., its OS goes back to a clean trusted snapshot on restart. The secure workspace 115 may record which applications the user installed and upon a revert to snapshot, reinstall the user-installed applications from a trusted catalogue once the workspace 115 is recreated. This ensures that any infected application will not persist when the workspace 115 is reinitiated, and at the same time user-installed apps are still available after the workspace is recreated.

In yet another embodiment, the secure workspace 115 is configured to provide a full recording of all activity performed in the workspace 115. Such activities may include keystrokes, mouse movements, network, file access, screen captures, and so on. The recording may be saved in the provisioning system (130, FIG. 1) for future use in auditing activity.

In yet another embodiment, the secure workspace 115 is configured to add a watermark to any object (file, application, image, etc.) displayed within a desktop maintained by the workspace 115 or to the entire workspace desktop by overlaying a user identifier (e.g., user ID) in the displayed desktop picture multiple times, so that taking a photo of the screen keeps the user identifier as part of the photo. This is performed to discourage taking and distributing pictures of sensitive information. The watermark is added as a unique pattern at the pixel level but without interfering with the user's work, by making the watermark blend with the displayed content via partial text opacity.

In an embodiment, when the user tries to install or launch an application or any executable code in the host OS 210, the secured workspace 215 can automatically install and/or launch such application in the workspace 215 as a new application 230.

In some configurations, the host OS 210 can optionally provide a file context menu (e.g., a right-click menu) that presents options to copy, move or launch files (e.g., documents) in the secured workspace 215. This option can be labeled in a way informing the user where to run the application (e.g., “launch in a secured workspace” or “launch as <PERSONAL IDENTITY>”).

Typically, operating systems can identify and mark risky, external and/Internet files, for example, email attachments, or downloaded files. According to an embodiment, such files are marked by the host 210 and opened automatically only in the secured workspace 215.

In another embodiment, when saving files in the secured workspace 215, the filesystem (not shown) automatically launches the file save dialog of the host OS 210 and completely hides the filesystem of the secured workspace 215. Each saved file in the host OS 210 originating from the secured workspace 215 is protected, so that the file is never opened in the host OS 210 and only in the secured workspace 215. The saved file can also go through content disarmament and reconstruction before being saved in the host OS 210. The saved file can also be watermarked to indicate it arrived from the secured workspace 215.

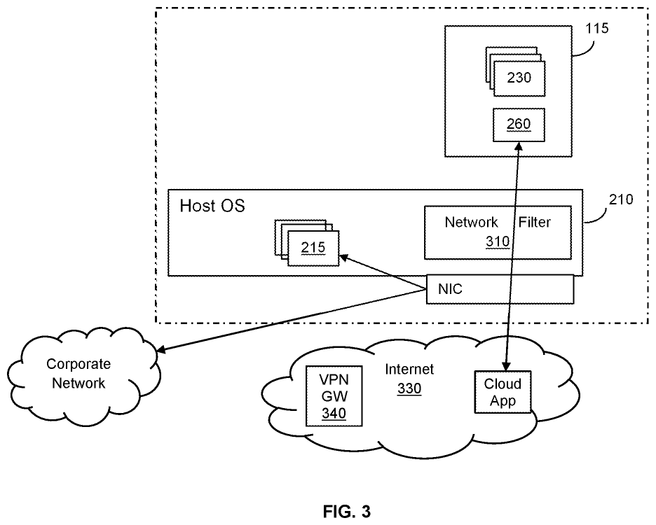

In an optional embodiment, a virtual network interface 260 is also configured in the secured workspace 215. The virtual network interface 260 is a piece of logic configured to tunnel all traffic to the unsecured network (the Internet). The logic may be realized as a set of rules, a state machine, and the like. In another embodiment, the interface 260 may be realized as a virtual machine. The operation of the virtual network interface 260 is discussed in FIG. 3.

In yet another embodiment, the secured workspace 115 is provided to clipboard security controls. This is performed by limiting the clipboard operations from/to applications 230. This limitation includes completely block clipboard operations, only allow host->guest operations, only allow guest->host operations, limit the size or throughput of clipboard transfers, limit the content type (e.g., certain file types, by inspecting file headers or by file extension), limit content by classification using 3rd-party digital rights management (DRM)/Data loss prevention (DLM) systems, detonating the content using 3rd-party content disarm and reconstruction (CDR) systems, and encrypting the content using 3rd-party encryption systems. The end-user cannot change these centrally managed policies as they are provisioned by the provisioning system (130, FIG. 1).

The disclosed embodiments further offer to prevent the automatic high-rate injection of keystrokes into the secured workspace 115. Thus, a malware trying to leak data by fast automatic keystroke typing would be blocked. To this end, the secured workspace 115 would limit the number of keystrokes per second to the typing rate of a fast-human operator. Alternatively, the secured workspace 115 may also include a low-level keyboard filter that may verify that keystrokes were generated by the physical keyboard and not by malware.

In an embodiment, the secured workspace 115 provides any external device security controls. This would limit access to any type of USB devices, printers, and other external devices. The external devices can whitelist/blacklist certain device families based on device “class” or a device unique identifier (ID).

The secured workspace 115 is also configured to enforce the USB policy to determine how applications 220 can access external devices (e.g., USB-based). For example, a disk-on-key cannot be accessed by the applications 220. This is performed by a filter driver (not shown) in the host OS 210 that passes all USB commands to the guest OS 230.

The secured workspace 115 is also configured to enforce a connectivity policy. The access to a peripheral device, as defined in such policy, can be defined by allowing, for example, the printing of documents from applications 220 into a network/corporate printer after converting the print job into an intermediate file format, or detonating the content and then passing the print job to the printer.

As noted above, the secured workspace 115 is a non-persistent virtual machine that may allow users to save documents, settings, and some applications 220. However, in any event, the guest OS of secured workspace 115 is returned to a clean state with every launch of the secured workspace 115. The user can choose to re-launch the workspace 115 at any point in time. In case of a malfunction of the guest OS 230 in the secured workspace 115, the workspace 115 can be automatically re-launched from a clean state, up to a predefined number of retries.

The user can choose to remove data and applications from the secured workspace 115 and bring it back to a completely clean state. In an embodiment, when the user installs applications 230 in the workspace 115, the applications 230 are “well-known” applications that are available in “portable” format or are available for silent unattended installation based on an online catalog of applications. The catalog of applications are vetted applications that are known to be secure and then automatically re-install them from the well-known secure clean sources upon launch of the workspace. This ensures that even if the user downloaded an infected version of the application, the workspace 115 will automatically re-install the application 220 from a clean safe source upon next launch, providing the user with a seamless experience of having the app installed without risking the secured workspace 115 with malicious content.

The user may be prompted when to restore the applications 220 or automatically restoring applications 220 when the workspace (VM) returns from a safe, trusted, catalog. The user can choose to back-up the data, settings, and applications of the workspace 215 into a cloud-based backup service. The user can then launch the same application(s) in the workspace with the stored data.

The embodiments are discussed with a reference to an example configuration where the host OS 210 is managed by the organization, thus can execute critical (corporate) applications and the workspace 115 provides defense for risky applications. However, the techniques discussed herein also provide solutions for the reverse scenario. In such an embodiment, a secured (corporate) workspace in an untrusted user device (workstation) is provided. That is, the physical workstation is an untrusted and unmanaged device, and the secured workspace would execute a managed host OS.

The secured workspace 115 when executing a managed host OS offers the following security controls in addition to the controls discussed above. The secured workspace 115 may include, but is not limited to, prevention of automatic high-rate injection of keystrokes into the secured workspace. Prevention of off-the-shelf (non-targeted) malware running on the workstation from running in the secured workspace, always executing a clean host OS image in the secured workspace, and full auditing of all activity in the secured workspace including keystrokes, mouse movements, display, network, and so on. This is possible as the secured workspace is dedicated in this case to accessing sensitive resources and is not mixed with the user's personal applications. Other controls include watermarking of everything displayed in the secured workspace to deter users from taking video/photo captures of sensitive data on the secured workspace. This watermarking works at the VM display level, thus apply on all applications in the same way.

The OS image in the secured workspace can be fully monitored and locked down to the extreme using code signing technologies, app whitelisting, and so on. A watchdog within the OS can attempt to verify that the OS have not been tampered with based on host OS health checks and ongoing verification that the standard OS security features are active.

All the controls discussed above are centrally managed through a provisioning system, for example the system 130, FIG. 1. One of the advantages of the disclosed embodiments is the ability to build a standard solution with a pre-configured policy that fits most companies (“one size fits all”). Such a policy may include the different types of policies discussed above and can be delivered at scale to millions of user devices with no need to define any policies on the customer's side.

FIG. 3 is an example diagram 300 illustrating the operation of the virtual network interface 260 and providing network communication protection according to an embodiment.

As illustrated in FIG. 3, the secured workspace 115 includes the virtual network interface 260 and applications 220 considered as risky applications. In the arrangement shown in FIG. 3, the host OS 210 executes sensitive (corporate) applications 215. Typically, a host OS operates in both user and kernel modes. The processor switches between the two modes depending on what type of code is running on the processor. Applications run in user mode, and core operating system components (e.g., drivers) run in kernel mode. In an embodiment, a networking filter 310 may be instantiated in the kernel mode. The networking filter is configured with the network policy to be enforced. In another embodiment, the networking filter 310 is replaced with a set of VPN rules set in the kernel mode.

Also illustrated in FIG. 3 are the organization network 320 and the Internet 330. The organization network 320 is a secured network that may host resources of the organization. The Internet is considered as unsecured network. Access to corporate applications through the Internet 330 may be via a VPN gateway 340. The VPN gateway 340 may be a cloud-based device. When the user device is connected to an external network and the host OS 210 is connected via the VPN gateway, it is desired that the traffic from the workspace 115 will not be directed via the VPN gateway 340, but rather connect directly to the external network. This can be performed by bridging the workspace 115 to a physical NIC, thereby bypassing the VPN software on the host OS 210 and tunneling the workspace 115 traffic directly to the physical NIC.

One of the risks is that the secured workspace 115 becomes infected and malware in this environment can reach the organization network 320 and propagate/infect organization resources. To protect against this risk, the workspace 115 may be tunneled out of the organization network 320 via a VPN tunnel directing all traffic out to the Internet. The VPN tunnel may be established by the host OS 210 or the networking filter 310. The VPN tunnel directs all traffic from the workspace 115 into the VPN gateway 340 and from there to the Internet. The tunneling of traffic ensures that no traffic from the workspace 115 reaches the organization network 320. Further, no traffic from the workspace 115 is processed by the host OS 210. It should be noted that the user of the user device does not have the credentials of the VPN gateway 340. It should be further noted that traffic from host OS 210 is not tunneled and can be directed to the organization network 320.

In an embodiment, the networking filter 310 is configured to inspect all traffic before such traffic is placed in the VPN tunnel, thereby allowing organizations to monitor/inspect the traffic of the workspace. It should be further noted that when the VPN tunnel is established by a networking filter 310, a vulnerability in the VPN tunnel logic is still contained in its own VM, thereby preventing the infection of the host OS 210.

In some embodiments, traffic from the secured workspace 115 can only access network resources that were not accessed by the host OS 210. Thus, beyond being tunneled into the VPN gateway, if the user attempts to access an internal corporate resource or a cloud-based resource that is already being accessed by the host OS 210, such an attempt would be blocked and potentially be launched in the host OS 210.

In an embodiment, when the user tries to log-in with his corporate identity to the workspace 215, the networking filter 310 can automatically detect that and prevent such an attempt. This can be performed by one of the following techniques: prevent access to authentication URLs of well-known cloud-based identity providers (e.g., Microsoft®, Google®, etc.). Alternatively, when the user starts typing a corporate username or password (or a prefix of these credentials), such action will be blocked. Further, cloud-based systems can only allow authentication from user devices that contain a unique client certificate. The certificate is not stored or maintained in the workspace 115.

In yet another embodiment, the networking logic 260 can be configured to examine headers that identify tenant/domain and based on that information decide whether access is allowed in the workspace 115 or in the host OS 210. In other embodiments, when a user connects to a public Wi-Fi network with a captive portal, the workspace 215 may automatically launch the captive portal in the workspace 215, to eliminate risk to the host OS 210.

It should be noted that the disclosed embodiments allow to create a transparent proxy service in the workspace 115 that intercepts requests by a browser and/or application in the workspace 115 to verify the identity of the OS and transparently passes these requests to the host OS 210. Thus, such requests would appear as received from the host OS 210. The proxying service can be performed either via a browser extension or via an OS service that overrides the default OS service being responsible to prove the OS identity or a compliance status.

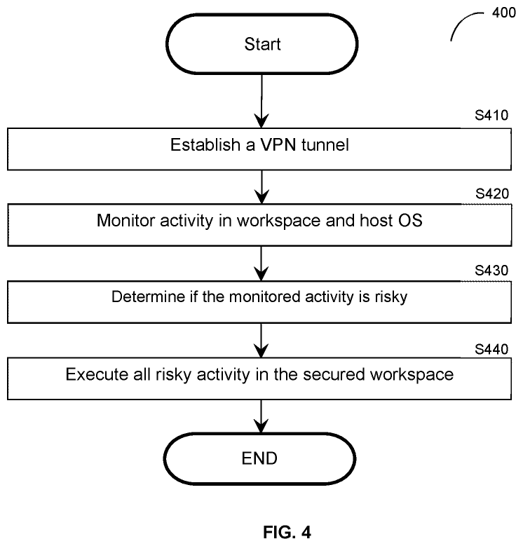

FIG. 4 is an example flowchart 400 illustrating the operation of the secured workspace in a user device according to an embodiment. The secured workspace is configured to provide a “sandbox” to execute risky applications or code that could harm the host OS 210 if executed therein.

Prior to execution of the method, a secured workspace is created and instantiated in the user device. In an embodiment, workspace creation includes preparing a virtual machine (VM) in advance. Such VM can be created either from existing OS file binaries, a clean OS version, or a pre-defined custom OS version with pre-installed applications. The secured workspace can be pre-installed with one or more applications of the organization (corporate) and run locally on a user device. The applications are executed in a guest OS which is part of the secured workspace.

In an embodiment, the created workspace can be deployed on an existing user device that was previously used for connecting to the organization via a VPN and it is now desired that such corporate VPN connection will be done from the guest OS. To achieve that, this may include mirroring the VPN software files and registry entries into a filesystem and registry of the workspace's guest OS. Then, the VPN software is disabled from loading in the host OS and is instead launched in the guest OS.

In another embodiment, a user's device is enrolled in a mobile device management (MDM) system that enforces compliance policies on the device (e.g., the device must have a password). Devices that do not meet these compliance policies cannot access the organization's resources (e.g., email), this can be enforced by a cloud access security broker. In one embodiment, the user's host OS (which can be a personal OS) can be enrolled in the MDM system while the guest corporate OS running in a VM on the device is not enrolled but needs access to corporate resources. When an application in the guest OS tries to access the organization's resources, such an application would be blocked.

To allow the guest OS to gain access to corporate resources in this scenario, a proxy service in the guest OS can intercept requests by a browser or application in the guest OS that attempts to verify the identity of the OS and transparently pass these requests to the host OS. To a cloud security broker, such requests would appear as received from the host OS, and thereby granting access to the application running in the guest OS. The proxying can be performed either via a browser extension or via an OS service that overrides the default OS service responsible for proving the OS identity/compliance status.

The secure workspace is non-persistent. When the workspace is recreated, the applications are restored or reinstalled from a trusted catalogue. The created secured workspace is rendered as a separate desktop and with a different appearance from the host OS.

At S410, once the secured workspace is running, a VPN tunnel is established between the secured workspace and a VPN gateway configured in the unsecured network (the Internet).

At S420, all activity is in the secured workspace and host OS are monitored. This includes monitoring any access to a web resource (e.g., application or website) inside or outside the organization, access to peripheral devices, opening files, launching applications, UX commands, and so on.

At S430, a determination of whether a monitored activity is risky, is performed. The determination whether an application is risky or not is based on a predefined security policy. As noted above, the security policy may include a network policy, a user interface (UX) policy, a security policy, a browsing policy, a list of trusted applications, and so on. A personal application, a file downloaded from the Internet, and an access to a disk-on-key are examples of activities determined as risky.

At S440, any activity determined as risky is executed or performed in the secured workspace. In addition, any traffic generated by the execution of such activity or applications hosted in the workspace, are tunneled via the VPN tunnel. For example, a personal application would be launched in the workspace, a file downloaded from the Internet is opened only in the workspace, an access to a disk-on-key will be blocked, and traffic will be tunneled to the Internet via the VPN tunnel. Other examples are discussed in greater detail below.

It should be noted that the disclosed embodiments and the secured workspace provide defense from cyber threats for a device and host OS that is managed by or unmanaged by an organization. Therefore, an organization can safely provide access to its resources, even from devices owned by the users. This increases productivity of the organization, while maintaining the security of sensitive resources.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing a managed and isolated workspace on a user device, comprising:
creating a secured workspace in the user device, wherein the secured workspace is separated from a host operating system and includes a guest operating system;
monitoring activity performed in the secured workspace and host operating system;
determining, based on a security policy, if the monitored activity is risky; and
causing execution of any determined risky activity in the secured workspace, thereby defending the host operating system from the determined risky activity, wherein the host operating system executes sensitive applications to an organization.

2. The method of claim 1, further comprising:
establishing a VPN tunnel between the secured workspace and an unsecured network, wherein the unsecured network is separated from a network of the organization.

3. The method of claim 1, further comprising:
rendering the secured workspace as a separate desktop on the user device; and
rendering the secured workspace to appear differently than the host operating system.

4. The method of claim 1, wherein the monitored activity includes any one of: launching an application, a user interface command, a filesystem command, a network access, a network connectivity, a peripheral device access, and a peripheral device connectivity.

5. The method of claim 1, wherein the security policy includes any one of: a catalog of trusted applications, a network policy, a user interface policy, a browsing policy, and a connectivity policy.

6. The method of claim 4, wherein causing execution of any determined risky activity in the secured workspace further comprises:
launching an application file determined to be risky in the secured workspace.

7. The method of claim 4, wherein causing execution of any determined risky activity in the secured workspace further comprises:
opening a file determined to be risky in the secured workspace.

8. The method of claim 4, wherein causing execution of any determined risky activity in the secured workspace further comprises:
allowing any peripheral device connectivity through the workspace only.

9. The method of claim 4, wherein causing execution of any determined risky activity in the secured workspace further comprises:
tunneling all traffic from the secured workspace via an established VPN tunnel.

10. The method of claim 4, causing execution of any determined risky activity in the secured workspace further comprises:
controlling user interface commands by performing at least one of: limiting clipboard operations and limiting keystroke injection.

11. The method of claim 1, further comprising:
watermarking any object displayed on the secured workspace.

12. The method of claim 1, wherein the creation of the secured workspace is performed using any one of: existing operating system file binaries, a clean operating system version, and a pre-defined custom operating system version with pre-installed applications.

13. The method of claim 1, wherein the secured workspace is non-persistent.

14. The method of claim 1, wherein the user device is any one of: a user device managed by the organization and a user device unmanaged by the organization.

15. The method of claim 1, wherein the secured workspace and host operating system are controlled by a hypervisor.

16. The method of claim 15, wherein the host operating system is executed by a hardware layer of the user device.

17. A non-transitory computer readable medium having stored thereon instructions for causing a processing circuitry to perform a process providing a managed and isolated workspace on a user device, the process comprising:
creating a secured workspace in the user device, wherein the secured workspace is separated from a host operating system and includes a guest operating system;
monitoring activity performed in the secured workspace and host operating system;
determining, based on a security policy, if the monitored activity is risky; and
causing execution of any determined risky activity in the secured workspace, thereby defending the host operating system from the determined risky activity, wherein the host operating system executes sensitive applications to an organization.

18. A system for providing a managed and isolated workspace on a user device, comprising:
a processing circuitry; and
a memory, the memory containing instructions that, when executed by the processing circuitry, configure the system to:
create a secured workspace in the user device, wherein the secured workspace is separated from a host operating system and includes a guest operating system;
monitor activity performed in the secured workspace and host operating system;
determine, based on a security policy, if the monitored activity is risky; and
cause execution of any determined risky activity in the secured workspace, thereby defending the host operating system from the determined risky activity, wherein the host operating system executes sensitive applications to an organization.
